(19) United States
(12) Patent Application Publication
(10) Pub. No.: US 2023/0365876 A1
(43) Pub. Date: Nov. 16, 2023

(54) SYSTEMS AND PROCESSES TO MAXIMIZE AROMATICS AND OLEFIN PRODUCTION

(71) Applicant: Saudi Arabian Oil Company, Dhahran (SA)

(72) Inventors: Lianhui Ding, Dhahran (SA); Sameer A. Al- Ghamdi, Dhahran (SA); Zhonglin Zhang, Dhahran (SA)

(73) Assignee: Saudi Arabian Oil Company, Dhahran (SA)

(21) Appl. No.: 17/745,248

(22) Filed: May 16, 2022

(51) Int. Cl. C10G 55/04; B01J 19/24; B01D 15/20

(52) U.S. Cl. CPC C10G 55/04; B01J 19/245; B01D 15/203; C10G 2400/30; C10G 2400/20; C10G 2400/22; C10G 2300/1044; B01J 2219/0004

(57) ABSTRACT

Processes and systems for forming olefins and aromatics from naphtha. The process includes introducing a naphtha feed stream to an adsorption unit, the adsorption unit comprising an adsorbent. N-paraffins are adsorbed from the naphtha feed stream to the adsorbent, and an iso-paraffin stream is removed from the adsorption unit. A desorbent stream is introduced into the adsorption unit, the desorbent stream comprising a desorbent, and the n-paraffins are removed from the adsorbent with the desorbent, thereby forming desorbed bottoms. The n-paraffins are collected from the desorbed bottoms, thereby forming an n-paraffin stream. The the n-paraffin stream is introduced to a steam cracking unit, and olefins and aromatics are formed from the n-paraffin stream in the steam cracking unit.

### BACKGROUND

### Field

The present disclosure relates to systems and processes for processing petroleum-based materials, in particular, systems and processes for upgrading and converting naphtha to petrochemical products, such as aromatics and olefins through steam cracking.

### Technical Background

Petrochemical feeds, such as naphtha, can be converted to chemical products and intermediates such as olefins and aromatic compounds, which are basic intermediates for a large portion of the petrochemical industry. The worldwide increasing demand for light olefins and aromatic compounds remains a major challenge for many integrated refineries. In particular, the production of some valuable light olefins such as ethylene, propene, and butene has attracted increased attention as pure olefin streams are considered the building blocks for polymer synthesis. Additionally, aromatic compounds such as benzene, toluene, ethylbenzene, and xylenes are valuable intermediates for synthesizing polymers and other organic compounds as well as for fuel additives.

Olefins and aromatic compounds can be produced through steam cracking naphtha. In order to obtain greater yields of olefins and aromatic compounds, suitable feedstocks for steam cracking processes are generally rich in paraffinic hydrocarbons with lesser concentrations of aromatic compounds, which may reduce the formation of undesired by-products and coke formation during steam cracking. However, even feed streams rich in paraffins can result in coke formation and undesired by-products in steam cracking.

### SUMMARY

Accordingly, there is an ongoing need for systems and processes for increasing the yield of olefins and aromatic compounds from a steam cracking process when naphtha is used as the feed stream into the cracking system.

Naphtha is a typical feed stream for steam cracking and reforming units. Naphtha generally comprises both normal paraffins (n-paraffins) and iso-paraffins. However, it has been found that the production of aromatics and olefins from Naphtha via steam cracking is not as efficient as it could be. Accordingly, it has been found that to increase the product of aromatics and olefins in steam cracking, n-paraffins are preferred as a feed stream to the steam cracker over iso-paraffins, which are preferred over naphthalene, which is preferred over aromatics. In contrast, reforming has the opposite preferred feed streams where aromatics are preferred as a feed stream over naphthalene, which is preferred over iso-paraffins, which are preferred over n-paraffins.

Therefore, to increase aromatics and olefin production in steam cracking, processes disclosed and described herein separate n-paraffins from iso-paraffins, naphthalenes, and aromatics by one or more solid adsorption units before sending the n-paraffins to a steam cracker and sending the iso-paraffins, naphthalenes, and aromatics to various other reformers. By utilizing processes and systems disclosed and described herein, ethylene yields can be increased by greater than 15 wt. %, total olefin yields can be increased by 6 wt. %; naphthalenes and aromatics in separated naphtha can be increased by 15 wt. %.

One aspect includes a process for forming olefins and aromatics from naphtha comprising: introducing a naphtha feed stream to an adsorption unit, the adsorption unit comprising an adsorbent; adsorbing n-paraffins from the naphtha feed stream to the adsorbent; removing an iso-paraffin stream from the adsorption unit; introducing a desorbent stream into the adsorption unit, the desorbent stream comprising a desorbent; removing the n-paraffins from the adsorbent with the desorbent, thereby forming desorbed bottoms; collecting the n-paraffins from the desorbed bottoms, thereby forming an n-paraffin stream; introducing the n-paraffin stream to a steam cracking unit; and forming olefins and aromatics from the n-paraffin stream in the steam cracking unit.

Another aspect includes a system for forming olefins and aromatics from naphtha, the system comprising: an adsorption unit upstream from and fluidly connected to a splitting unit and a steam cracking unit; the steam cracking unit is downstream from and fluidly connected to the adsorption unit and is upstream from and fluidly connected to a separation unit; the splitting unit is downstream from and fluidly connected to the adsorption unit, and is upstream from and fluidly connected to an aromatization unit and a reforming unit; the aromatization unit is downstream from and fluidly connected to the splitting unit, and is upstream from and fluidly connected to the separation unit; the reforming unit is downstream from and fluidly connected to the splitting unit, and is upstream from and fluidly connected to the separation unit; the separation unit is downstream from and fluidly connected to the aromatization unit and the reforming unit, and is downstream from and fluidly connected to the steam cracking unit, wherein the adsorption unit comprises an adsorbent selected from the group consisting of zeolite 5A, zeolite T, chabazite, and erionite.

Additional features and advantages of the technology described in this disclosure will be set forth in the detailed description which follows, and in part will be readily apparent to those skilled in the art from the description or recognized by practicing the technology as described in this disclosure, including the detailed description which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a generalized flow diagram of a system for forming olefins and aromatics from naphtha according to embodiments disclosed and described herein;

FIG. 2 schematically depicts a generalized flow diagram of an adsorption unit according to embodiments disclosed and described herein; and

FIG. 3 schematically depicts a generalized flow diagram of a steam cracking unit according to embodiments disclosed and described herein.

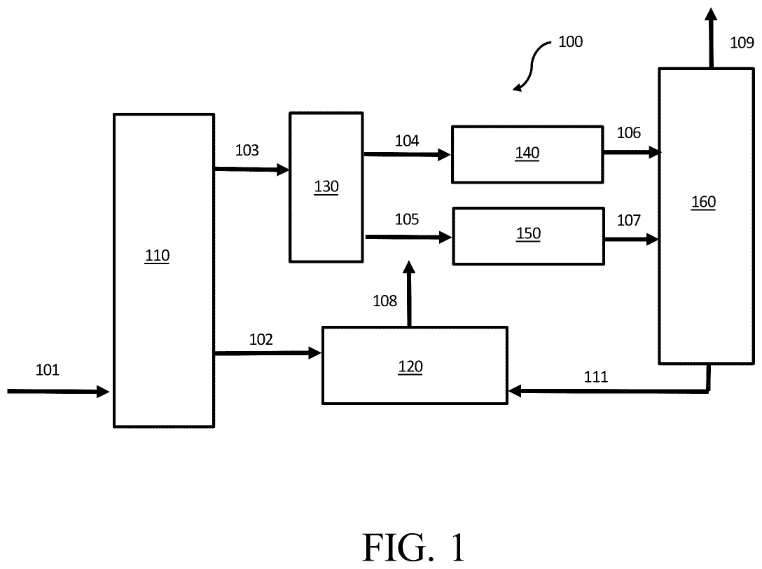

For the purpose of describing the simplified schematic illustrations and descriptions of FIGS. 1-3, the numerous valves, temperature sensors, electronic controllers and the like that may be employed and well known to those of ordinary skill in the art of certain chemical processing operations are not included. Further, accompanying components that are often included in chemical processing operations, such as, for example, air supplies, heat exchangers, surge tanks, or other related systems are not depicted. It would be known that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines which may serve to transfer process steams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that two or more process streams are “mixed” or “combined” when two or more lines intersect in the schematic flow diagrams of FIGS. 1-3. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

The present disclosure is directed to systems and methods for upgrading naphtha to produce more valuable chemical intermediates, such as olefins and aromatic compounds, for example. Referring to FIG. 1, an embodiment of a system 100 for upgrading a naphtha feed stream 101 is schematically depicted. The system 100 comprises an adsorption unit 110, a splitting unit 130, a steam cracking unit 120, an aromatization unit 140, a reforming unit 150, and a separating unit 160. The adsorption unit 110 is upstream from, and fluidly connected to, the splitting unit 130 and the steam cracking unit 120. The steam cracking unit 120 is downstream from, and fluidly connected to, the adsorption unit 110, and the steam cracking unit 120 is upstream from, and fluidly connected to, the separating unit 160. The splitting unit 130 is downstream from, and fluidly connected to, the adsorption unit 110, and the splitting unit 130 is upstream from, and individually fluidly connected to, both the aromatization unit 140 and the reforming unit 150. The aromatization unit 140 is downstream from, and fluidly connected to, the splitting unit 130, and the aromatization unit is upstream from, and fluidly connected to, the separating unit 160. The reforming unit 150 is downstream from, and fluidly connected to, the splitting unit 130, and the reforming unit is upstream from, and fluidly connected to, the separating unit 160. The separating unit 160 is downstream from, and individually fluidly connected to, both the aromatization unit 140 and the reforming unit 150, and the separation unit is fluidly connected to the steam cracking unit 120.

Processes for reforming naphtha to benzene, toluene, xylene (BTX), and olefins using the system 100 will now be described with reference again to FIG. 1. A feed stream naphtha comprising naphtha is introduced into the adsorption unit 110 where n-paraffins are separated from iso-paraffins. An n-paraffin stream 102 exits the adsorption unit 110 and is introduced into the steam cracking unit 120. An iso-paraffin stream 103 exits the adsorption unit 110 and is introduced into the splitting unit 130. As noted above, the n-paraffin stream 102 is introduced into the steam cracking unit 120 where the n-paraffin stream is converted to a first BTX and olefin stream 108. The first BTX and olefin stream 108 may then be used in additional chemical processes. The iso-paraffin stream 103 that exits the adsorption unit 110 is introduced into the splitting unit 130 where the iso-paraffin stream 103 is split into a lower boiling point iso-paraffin stream 104 and a higher boiling point iso-paraffin stream 105. The lower boiling point iso-paraffin stream 104 exits the splitting unit 130 and is introduced into the aromatization unit 140 where iso-paraffins in the lower boiling point iso-paraffin stream 104 are converted to BTX and olefins. An aromatized stream 106 exits the aromatization unit 140 and is introduced into the separating unit 160. The higher boiling point iso-paraffin stream 105 exits the splitting unit 130 and is introduced into the reforming unit 150 where iso-paraffins in the higher boiling iso-paraffin stream are reformed into BTX and olefins. A reformed stream 107 exits the reforming unit 150 and is introduced to the separating unit 160. In the separating unit 160, the aromatized stream 106 and the reformed stream 107 are combined and the BTX and olefins from the aromatized stream 106 and the BTX and olefins from the reformed stream 107 are separated from other constituents in the aromatized stream 106 and other constituents from the reformed stream 107. The BTX and olefins from the aromatized stream 106 and the BTX and olefins from the reformed stream 107 exit the separating unit as a second BTX and olefin stream 109. The second BTX and olefin stream 109 may then be used in additional chemical processes. The other constituents from the aromatized stream 106 and the other constituents from the reformed stream 107 exit the separating unit 160 as raffinate stream 111 and is introduced into the steam cracking unit 120. In the steam cracking unit 120, raffinate stream 111 is combined with the n-paraffin stream 102 and converted to BTX and olefins.

The systems and processes of the present disclosure provide for improved conversion of naphtha to olefins and aromatic compounds through steam cracking and reforming. The systems and processes of the present disclosure separates n-paraffins from iso-paraffins from a naphtha feed stream prior to introducing a stream to a steam cracking unit. As discussed above, n-paraffins have been found to be a preferred feed compared to iso-paraffins. Accordingly, by separating n-paraffins from iso-paraffins in the naphtha feed stream and introducing a n-paraffin-rich stream to the steam cracking unit, an increased yield of olefins, aromatic compounds, or both from the naphtha compared to other steam cracking processes may be achieved, among other features.

As used in this disclosure, a “separating unit” or “splitting unit” refers to any separating device that at least partially separates one or more chemicals in a mixture from one another. For example, a separating unit or splitting unit may selectively separate different chemical species from one another, forming one or more chemical fractions. Examples of separating units or splitting units include, without limitation, distillation columns, fractionators, flash drums, knock-out drums, knock-out pots, centrifuges, filtration devices, traps, scrubbers, expansion devices, membranes, solvent extraction devices, high-pressure separators, low-pressure separators, and the like. It should be understood that separating or splitting processes described in this disclosure may not completely separate all of one chemical consistent from all of another chemical constituent. It should be understood that the separating or splitting processes described in this disclosure “at least partially” separate different chemical components from one another, and that even if not explicitly stated, it should be understood that separating or splitting may include only partial separating. As used in this disclosure, one or more chemical constituents may be “separated” or “split” from a process stream to form a new process stream. Generally, a process stream may enter a separating unit or a splitting unit and be divided or separated into two or more process streams of desired composition.

As used in this disclosure, the term “fractionating” may refer to a process of separating one or more constituents of a composition in which the constituents are divided from each other during a phase change based on differences in properties of each of the constituents. As an example, as used in this disclosure, “distillation” refers to separation of constituents of a liquid composition based on differences in the boiling point temperatures of constituents of a composition.

Further, in some separation processes, a “lower-boiling” effluent and a “higher-boiling” effluent or the like may separately exit the separation unit or splitting unit. In general, the lower-boiling effluent has a lower boiling point temperature than the higher-boiling effluent. Some separation systems may produce a “middle-boiling effluent,” which may include constituents having boiling point temperatures between the boiling point temperatures of the lower-boiling effluent and the higher-boiling effluent. The middle-boiling effluent may be referred to as a middle distillate. Some separation systems may be operable to produce a plurality of streams, each with a different boiling point range. It should be additionally understood that where only one separation unit is depicted in a figure or described, two or more separation units may be employed to carry out the identical or substantially identical separations. For example, where a distillation column with multiple outlets is described, it is contemplated that several separators arranged in series may equally separate the feed stream and such embodiments are within the scope of the presently described embodiments.

As used in this disclosure, the terms “upstream” and “downstream” may refer to the relative positioning of unit operations with respect to the direction of flow of the process streams. A first unit operation of a system may be considered “upstream” of a second unit operation if process streams flowing through the system encounter the first unit operation before encountering the second unit operation. Likewise, a second unit operation may be considered “downstream” of the first unit operation if the process streams flowing through the system encounter the first unit operation before encountering the second unit operation.

As used in the present disclosure, passing a stream or effluent from one unit “directly” to another unit may refer to passing the stream or effluent from the first unit to the second unit without passing the stream or effluent through an intervening reaction system or separation system that substantially changes the composition of the stream or effluent. Heat transfer devices, such as heat exchangers, preheaters, coolers, condensers, or other heat transfer equipment, and pressure devices, such as pumps, pressure regulators, compressors, or other pressure devices, are not considered to be intervening systems that change the composition of a stream or effluent. Combining two streams or effluents together also is not considered to comprise an intervening system that changes the composition of one or both of the streams or effluents being combined.

As used in this disclosure, the term “effluent” may refer to a stream that is passed out of a reactor, a reaction zone, or a separation unit following a particular reaction or separation. Generally, an effluent has a different composition than the stream that entered the separation unit, reactor, or reaction zone. It should be understood that when an effluent is passed to another system unit, only a portion of that system stream may be passed. For example, a slip stream may carry some of the effluent away, meaning that only a portion of the effluent may enter the downstream system unit. The term “reaction effluent” may more particularly be used to refer to a stream that is passed out of a reactor or reaction zone.

As used herein, a “fixed-bed,” specifically in reference to adsorption zones, refers to an absorbent bed inside an adsorption zone that is not displaced by fluids entering and exiting the adsorption zone, i.e., the adsorbents remain in place.

As used in this disclosure, “cracking” generally refers to a chemical reaction where a molecule having carbon-carbon bonds is broken into more than one molecule by the breaking of one or more of the carbon-carbon bonds; where a compound including a cyclic moiety, such as an aromatic, is converted to a compound that does not include a cyclic moiety; or where a molecule having carbon-carbon double bonds are reduced to carbon-carbon single bonds. Some catalysts may have multiple forms of catalytic activity, and calling a catalyst by one particular function does not render that catalyst incapable of being catalytically active for other functionality. As used throughout the present disclosure, “hydrocracking” may refer to catalytic cracking of hydrocarbons conducted in the presence of hydrogen.

As used throughout the present disclosure, the term “butene” or “butenes” refer to one or more than one of 1-butene, trans-2-butene, cis-2-butene, isobutene, or mixtures of these isomers. As used throughout the present disclosure, the term “normal butenes” may refer to one or more than one of 1-butene, trans-2-butene, cis-2-butene, or mixtures of these isomers, and does not include isobutene. As used throughout the present disclosure, the term “2-butene” may refer to trans-2-butene, cis-2-butene, or a mixture of these two isomers.

As used throughout the present disclosure, the term “xylenes,” when used without a designation of the isomer, such as the prefix para, meta, or ortho (or letters p, m, and o, respectively), may refer to one or more of meta-xylene, ortho-xylene, para-xylene, and mixtures of these xylene isomers.

As used throughout the present disclosure, the term “naphtha” may refer a mixture of many different hydrocarbon compounds. It has an initial boiling point (IBP) of about 35° C. and a final boiling point (FBP) of about 200° C., and it contains paraffins, naphthenes (cyclic paraffins) and aromatic hydrocarbons ranging from those containing 4 carbon atoms to those containing about 10 or 11 carbon atoms.

It should further be understood that streams may be named for the components of the stream, and the component for which the stream is named may be the major component of the stream (such as comprising from 50 wt. %, from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “hydrogen stream” passing to a first system component or from a first system component to a second system component should be understood to equivalently disclose “hydrogen” passing to the first system component or passing from a first system component to a second system component.

Referring again to FIG. 1, the naphtha feed stream 101 is introduced into the adsorption unit 110. The naphtha feed stream 101 may, in one or more embodiments, be overhead from a crude oil distillation column, from hydrocracking, from fluidic catalytic cracking (FCC), or from coking and comprises n-paraffins and iso-paraffins. In embodiments, the naphtha feed stream comprises other constituents such as, for example, aromatics and olefins. The adsorption unit 110 is operable to separate n-paraffins from iso-paraffins present in the naphtha feed stream 101. According to embodiments, the naphtha feed stream 101 comprises from 50 wt % to 80 wt % paraffins (including both n-paraffins and iso-paraffins), such as from 55 wt % to 75 wt %, or from 60 wt % to 70 wt %. The molar ratio of iso-paraffins to n-paraffins in the naphtha feed stream 101 is from 0.8 to 5.0, such as from 1.0 to 4.5, from 1.5 to 4.0, from 2.0 to 3.5, or from 2.0 to 3.0.

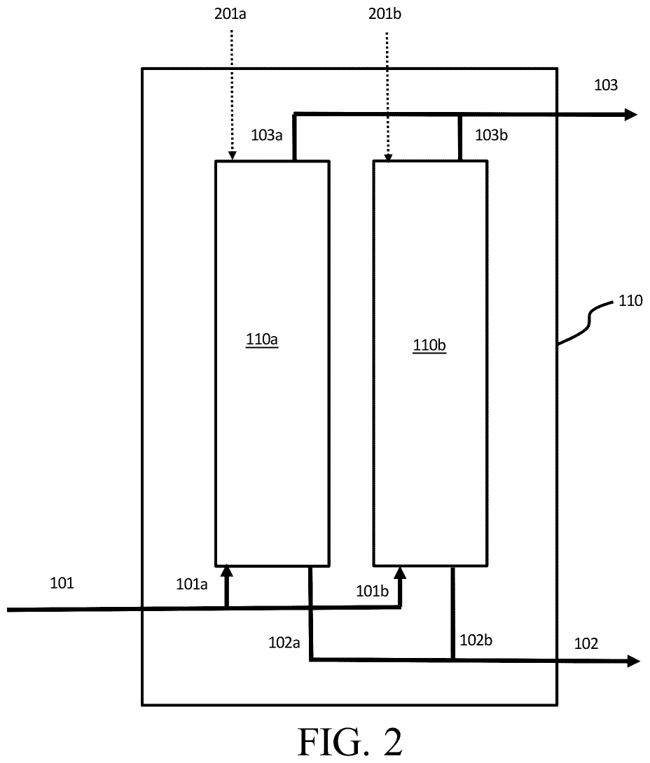

Embodiments of the adsorption unit 110 will now be described in more detail with reference to FIG. 2. In embodiments, the adsorption unit 110 comprise multiple adsorption zones 110a and 110b. The adsorption unit 110 is depicted in FIG. 2 as having two adsorption zones 110a and 110b for ease of illustration and description. However, the adsorption unit 110 may have greater than or equal to two adsorption zones, such as 2, 3, 4, 5, 6, 7, 8, or more than 8 adsorption zones. In embodiments, each absorption zone is a fixed-bed adsorption zone packed with adsorbent. The naphtha feed stream 101 is fed to the bottom first adsorption zone 110a as a first naphtha feed stream 101a. As the naphtha fills the first adsorption zone 110a, n-paraffins are adsorbed by the adsorbents that are packed into the first adsorption zone 110a and iso-paraffins and other constituents in the first naphtha feed stream 101a pass through the first adsorption zone 110a and exit the first adsorption zone 110a as a first iso-paraffin stream 103a. The flow of the first naphtha feed stream 101a to the first adsorption zone 110a is continued until the adsorbent loaded into the first adsorption zone 110a is saturated with n-paraffins.

Once the adsorbent loaded into the first adsorption zone 110a is saturated with n-paraffins, the naphtha feed stream 101 is made to bypass the first adsorption zone 110a, such as by a valve or the like, and the naphtha feed stream 101 is fed into the second adsorption zone 110b via a second naphtha feed stream 101b. As the naphtha fills the second adsorption zone 110b, n-paraffins are adsorbed by the adsorbents that are packed into the second adsorption zone 110b and iso-paraffins and other constituents in the second naphtha feed stream 101b pass through the second adsorption zone 110b and exit the second adsorption zone 110b as a second iso-paraffin stream 103b. The flow of the second naphtha feed stream 101b to the second adsorption zone 110b is continued until the adsorbent loaded into the second adsorption zone 110b is saturated with n-paraffins.

In embodiments, the saturated adsorbent in the first adsorption zone 110a is regenerated by feeding a desorbent into the first adsorption zone 110a. During this process the naphtha feed stream 101 is directed to the second adsorption zone 110b via the second naphtha feed stream 101b, and the naphtha feed stream 101 is not fed into the first adsorption zone 110a. The desorbent is, in embodiments, added into the top of the first adsorption zone 110a via a first desorbent stream 201a where the desorbent desorbs the n-paraffins from the absorbent in the first adsorption zone 110a. The desorbed bottoms comprises n-paraffins and desorbent. The desorbent in the desorbed bottoms is flushed and recycled to be used again in the first desorbent stream 201a. The n-paraffins in the desorbed bottoms exits the bottom of the first adsorption zone 110a as a first n-paraffin stream 102a.

In embodiments, the saturated adsorbent in the second adsorption zone 110b is regenerated by feeding a desorbent into the second adsorption zone 110b. During this process the naphtha feed stream 101 is directed to the first adsorption zone 110a via the first naphtha feed stream 101a, and the naphtha feed stream 101 is not fed into the second adsorption zone 110b. The desorbent is, in embodiments, added into the top of the second adsorption zone 110b via a second desorbent stream 201b where the desorbent desorbs the n-paraffins from the absorbent in the second adsorption zone 110b. The desorbed bottoms comprises n-paraffins and desorbent. The desorbent in the desorbed bottoms is flushed and recycled to be used again in the second desorbent stream 201b. The n-paraffins in the desorbed bottoms exits the bottom of the second adsorption zone 110b as a second n-paraffin stream 102b.

It should be understood that in embodiments any number of adsorption zones may be included in the adsorption unit 110, and that in embodiments with three or more adsorption zones present in the adsorption unit 110, the naphtha feed stream 101 may be simultaneously introduced into multiple adsorption zones. Likewise, in embodiments with three or more adsorption zones present in the adsorption unit 110, regeneration with desorbent may simultaneously take place in more than one adsorption zone. Process conditions for the adsorption and regeneration processes are described in more detail below. It should be understood that these process conditions apply to both the first adsorption zone 110a and the second adsorption zone 110b as well as any number of other adsorption zones present in the adsorption unit 110.

In one or more embodiments, the adsorbent is a zeolite A as described by the International Zeolite Association (IZA). In general, and without limitation, Zeolite A is an aluminosilicate having a formula of [Na⁺₁₂(H₂O)₂₇]₈[Al₁₂Si₂₂O₄₈]₈ and have sodalite cages connected by four-membered rings forming a three-dimensional network. The sodium can be replaced with lithium, potassium, or calcium to alter the size of the ring openings and, thus, vary the adsorbing properties of the zeolite A adsorbent. In embodiments, the adsorbent is zeolite 5A as defined by IZA. Zeolite 5A is, generally and without limitation, a calcium-based zeolite A structure having ring openings of approximately 5 angstroms (Å) or 0.5 nm. Thus, zeolite 5A generally absorbs molecules with diameters less than 5 Å. In embodiments, the adsorbent may be zeolite T as described in U.S. Pat. No. 2,950,952, chabazite, or erionite. The adsorbent may, in embodiments, be provided in the form of pellets that are loaded into an adsorption zone. The pellets may, in embodiments, have an average size that is from 1 mm to 7 mm, where the dimension is measured along the longest axis of the pellet. In embodiments, the pellets may have an average size that is from 2 mm to 7 mm, from 3 mm to 7 mm, from 4 mm to 7 mm, from 5 mm to 7 mm, from 6 mm to 7 mm, from 1 mm to 6 mm, from 2 mm to 6 mm, from 3 mm to 6 mm, from 4 mm to 6 mm, from 5 mm to 6 mm, from 1 mm to 5 mm, from 2 mm to 5 mm, from 3 mm to 5 mm, from 4 mm to 5 mm, from 1 mm to 4 mm, from 2 mm to 4 mm, from 3 mm to 4 mm, from 1 mm to 3 mm, from 2 mm to 3 mm, or from 1 mm to 2 mm.

In embodiments, before the adsorbent is exposed to the naphtha feed stream 101, the adsorbent is dried in either nitrogen or atmospheric air at a temperature ranging from 350° C. to 550° C., for a duration ranging from 2 hours to 12 hours. In one or more embodiments, the adsorbent is dried at a temperature from 375° C. to 550° C., from 400° C. to 550° C., from 425° C. to 550° C., from 450° C. to 550° C., from 475° C. to 550° C., from 500° C. to 550° C., from 525° C. to 550° C., from 350° C. to 525° C., from 375° C. to 525° C., from 400° C. to 525° C., from 425° C. to 525° C., from 450° C. to 525° C., from 475° C. to 525° C., from 500° C. to 525° C., from 350° C. to 500° C., from 375° C. to 500° C., from 400° C. to 500° C., from 425° C. to 500° C., from 450° C. to 500° C., from 475° C. to 500° C., from 350° C. to 475° C., from 375° C. to 475° C., from 400° C. to 475° C., from 425° C. to 475° C., from 450° C. to 475° C., from 350° C. to 450° C., from 375° C. to 450° C., from 400° C. to 450° C., from 425° C. to 450° C., from 350° C. to 425° C., from 375° C. to 425° C., from 400° C. to 425° C., from 350° C. to 400° C., from 375° C. to 400° C., or from 350° C. to 375° C. In embodiments, the adsorbent is dried for a time period from 4 hours to 12 hours, from 6 hours to 12 hours, from 8 hours to 12 hours, from 10 hours to 12 hours, from 2 hours to 10 hours, from 4 hours to 10 hours, from 6 hours to 10 hours, from 8 hours to 10 hours, from 2 hours to 8 hours, from 4 hours to 8 hours, from 6 hours to 8 hours, from 2 hours to 6 hours, from 4 hours to 6 hours, or from 2 hours to 4 hours.

During the adsorption process when the n-paraffins are being adsorbed by the adsorbent in an adsorption zone, the adsorption zone operates, according to embodiments, at atmospheric pressure and a temperature that is from 100° C. to 300° C. In embodiments, the temperature during the adsorption process is from 125° C. to 300° C., from 150° C. to 300° C., from 175° C. to 300° C., from 200° C. to 300° C., from 225° C. to 300° C., from 250° C. to 300° C., from 275° C. to 300° C., from 100° C. to 275° C., from 125° C. to 275° C., from 150° C. to 275° C., from 175° C. to 275° C., from 200° C. to 275° C., from 225° C. to 275° C., from 250° C. to 275° C., from 100° C. to 250° C., from 125° C. to 250° C., from 150° C. to 250° C., from 175° C. to 250° C., from 200° C. to 250° C., from 225° C. to 250° C., from 100° C. to 225° C., from 125° C. to 225° C., from 150° C. to 225° C., from 175° C. to 225° C., from 200° C. to 225° C., from 100° C. to 200° C., from 125° C. to 200° C., from 150° C. to 200° C., from 175° C. to 200° C., from 100° C. to 175° C., from 125° C. to 175° C., from 150° C. to 175° C., from 100° C. to 150° C., from 125° C. to 150° C., or from 100° C. to 125° C.

In one or more embodiments, the flow of the naphtha feed stream 101 to the adsorption zone during the adsorption process is a liquid hourly space velocity (LHSV) from 0.001 per hour (h⁻¹) to 10 h⁻¹, such as from 0.01 h⁻¹ to 10 h⁻¹, from 0.1 h⁻¹ to 10 h⁻¹, from 0.5 h⁻¹ to 10 h⁻¹, from 1 h⁻¹ to 10 h⁻¹, from 2 h⁻¹ to 10 h⁻¹, from 3 h⁻¹ to 10 h⁻¹, from 4 h⁻¹ to 10 h⁻¹, from 5 h⁻¹ to 10 h⁻¹, from 6 h⁻¹ to 10 h⁻¹, from 7 h⁻¹ to 10 h⁻¹, from 8 h⁻¹ to 10 h⁻¹, from 9 h⁻¹ to 10 h⁻¹, from 0.001 h⁻¹ to 9 h⁻¹, from 0.01 h⁻¹ to 9 h⁻¹, from 0.1 h⁻¹ to 9 h⁻¹, from 0.5 h⁻¹ to 9 h⁻¹, from 1 h⁻¹ to 9 h⁻¹, from 2 h⁻¹ to 9 h⁻¹, from 3 h⁻¹ to 9 h⁻¹, from 4 h⁻¹ to 9 h⁻¹, from 5 h⁻¹ to 9 h⁻¹, from 6 h⁻¹ to 9 h⁻¹, from 7 h⁻¹ to 9 h⁻¹, from 8 h⁻¹ to 9 h⁻¹, from 0.001 h⁻¹ to 8 h⁻¹, from 0.01 h⁻¹ to 8 h⁻¹, from 0.1 h⁻¹ to 8 h⁻¹, from 0.5 h⁻¹ to 8 h⁻¹, from 1 h⁻¹ to 8 h⁻¹, from 2 h⁻¹ to 8 h⁻¹, from 3 h⁻¹ to 8 h⁻¹, from 4 h⁻¹ to 8 h⁻¹, from 5 h⁻¹ to 8 h⁻¹, from 6 h⁻¹ to 8 h⁻¹, from 7 h⁻¹ to 8 h⁻¹, from 0.001 h⁻¹ to 7 h⁻¹, from 0.01 h⁻¹ to 7 h⁻¹, from 0.1 h⁻¹ to 7 h⁻¹, from 0.5 h⁻¹ to 7 h⁻¹, from 1 h⁻¹ to 7 h⁻¹, from 2 h⁻¹ to 7 h⁻¹, from 3 h⁻¹ to 7 h⁻¹, from 4 h⁻¹ to 7 h⁻¹, from 5 h⁻¹ to 7 h⁻¹, from 6 h⁻¹ to 7 h⁻¹, from 0.001 h⁻¹ to 6 h⁻¹, from 0.01 h⁻¹ to 6 h⁻¹, from 0.1 h⁻¹ to 6 h⁻¹, from 0.5 h⁻¹ to 6 h⁻¹, from 1 h⁻¹ to 6 h⁻¹, from 2 h⁻¹ to 6 h⁻¹, from 3 h⁻¹ to 6 h⁻¹, from 4 h⁻¹ to 6 h⁻¹, from 5 h⁻¹ to 6 h⁻¹, from 0.001 h⁻¹ to 5 h⁻¹, from 0.01 h⁻¹ to 5 h⁻¹, from 0.1 h⁻¹ to 5 h⁻¹, from 0.5 h⁻¹ to 5 h⁻¹, from 1 h⁻¹ to 5 h⁻¹, from 2 h⁻¹ to 5 h⁻¹, from 3 h⁻¹ to 5 h⁻¹, from 4 h⁻¹ to 5 h⁻¹, from 0.001 h⁻¹ to 4 h⁻¹, from 0.01 h⁻¹ to 4 h⁻¹, from 0.1 h⁻¹ to 4 h⁻¹, from 0.5 h⁻¹ to 4 h⁻¹, from 1 h⁻¹ to 4 h⁻¹, from 2 h⁻¹ to 4 h⁻¹, from 3 h⁻¹ to 4 h⁻¹, from 0.001 h⁻¹ to 3 h⁻¹, from 0.01 h⁻¹ to 3 h⁻¹, from 0.1 h⁻¹ to 3 h⁻¹, from 0.5 h⁻¹ to 3 h⁻¹, from 1 h⁻¹ to 3 h⁻¹, from 2 h⁻¹ to 3 h⁻¹, from 0.001 h⁻¹ to 2 h⁻¹, from 0.01 h⁻¹ to 2 h⁻¹, from 0.1 h⁻¹ to 2 h⁻¹, from 0.5 h⁻¹ to 2 h⁻¹, from 1 h⁻¹ to 2 h⁻¹, from 0.001 h⁻¹ to 1 h⁻¹, from 0.01 h⁻¹ to 1 h⁻¹, from 0.1 h⁻¹ to 1 h⁻¹, from 0.5 h⁻¹ to 1 h⁻¹, from 0.001 h⁻¹ to 0.5 h⁻¹, from 0.01 h⁻¹ to 0.5 h⁻¹, from 0.1 h⁻¹ to 0.5 h⁻¹, from 0.001 h⁻¹ to 0.1 h⁻¹, from 0.01 h⁻¹ to 0.1 h⁻¹, or from 0.001 h⁻¹ to 0.01 h⁻¹.

In one or more embodiments, the iso-paraffin stream 103 that exits the adsorption unit comprises at least 95 wt. % iso-paraffins, such as at least 95.5 wt. % iso-paraffins, at least 96.0 wt. % iso-paraffins, at least 96.5 wt. % iso-paraffins, at least 97.0 wt. % iso-paraffins, at least 97.5 wt. % iso-paraffins, at least 98.0 wt. % iso-paraffins, at least 98.5 wt. % iso-paraffins, at least 99.0 wt. % iso-paraffins, or at least 99.5 wt. % iso-paraffins. In embodiments, the iso-paraffin stream 103 that exits the adsorption unit comprises from 95.0 wt. % to 99.5 wt. % iso-paraffins, such as from 95.5 wt. % to 99.5 wt. % iso-paraffins, from 96.0 wt. % to 99.5 wt. % iso-paraffins, from 96.5 wt. % to 99.5 wt. % iso-paraffins, from 97.0 wt. % to 99.5 wt. % iso-paraffins, from 97.5 wt. % to 99.5 wt. % iso-paraffins, from 98.0 wt. % to 99.5 wt. % iso-paraffins, from 98.5 wt. % to 99.5 wt. % iso-paraffins, from 99.0 wt. % to 99.5 wt. % iso-paraffins, from 95.0 wt. % to 99.0 wt. % iso-paraffins, from 95.5 wt. % to 99.0 wt. % iso-paraffins, from 96.0 wt. % to 99.0 wt. % iso-paraffins, from 96.5 wt. % to 99.0 wt. % iso-paraffins, from 97.0 wt. % to 99.0 wt. % iso-paraffins, from 97.5 wt. % to 99.0 wt. % iso-paraffins, from 98.0 wt. % to 99.0 wt. % iso-paraffins, from 98.5 wt. % to 99.0 wt. % iso-paraffins, from 95.0 wt. % to 98.5 wt. % iso-paraffins, from 95.5 wt. % to 98.5 wt. % iso-paraffins, from 96.0 wt. % to 98.5 wt. % iso-paraffins, from 96.5 wt. % to 98.5 wt. % iso-paraffins, from 97.0 wt. % to 98.5 wt. % iso-paraffins, from 97.5 wt. % to 98.5 wt. % iso-paraffins, from 98.0 wt. % to 98.5 wt. % iso-paraffins, from 95.0 wt. % to 98.0 wt. % iso-paraffins, from 95.5 wt. % to 98.0 wt. % iso-paraffins, from 96.0 wt. % to 98.0 wt. % iso-paraffins, from 96.5 wt. % to 98.0 wt. % iso-paraffins, from 97.0 wt. % to 98.0 wt. % iso-paraffins, from 97.5 wt. % to 98.0 wt. % iso-paraffins, from 95.0 wt. % to 97.5 wt. % iso-paraffins, from 95.5 wt. % to 97.5 wt. % iso-paraffins, from 96.0 wt. % to 97.5 wt. % iso-paraffins, from 96.5 wt. % to 97.5 wt. % iso-paraffins, from 97.0 wt. % to 97.5 wt. % iso-paraffins, from 95.0 wt. % to 97.0 wt. % iso-paraffins, from 95.5 wt. % to 97.0 wt. % iso-paraffins, from 96.0 wt. % to 97.0 wt. % iso-paraffins, from 96.5 wt. % to 97.0 wt. % iso-paraffins, from 95.0 wt. % to 96.5 wt. % iso-paraffins, from 95.5 wt. % to 96.5 wt. % iso-paraffins, from 96.0 wt. % to 96.5 wt. % iso-paraffins, from 95.0 wt. % to 96.0 wt. % iso-paraffins, from 95.5 wt. % to 96.0 wt. % iso-paraffins, or from 95.0 wt. % to 95.5 wt. % iso-paraffins.

After the adsorbent is saturated with n-paraffins, the flow of the naphtha feed stream 101 to the adsorption zone with the saturated adsorbent is discontinued and a flow of desorbent is introduced into the adsorption zone to regenerate the adsorbent. In embodiments, the desorbent used to regenerate the adsorbent is selected from n-pentane or hexane. In one or more embodiments, the desorbent is n-pentane.

During the regeneration process where n-paraffins in the adsorbent are desorbed by the desorbent in an adsorption zone, the adsorption zone operates, according to embodiments, at atmospheric pressure and a temperature that is from 100° C. to 300° C. In embodiments, the temperature during the regeneration process is from 125° C. to 300° C., from 150° C. to 300° C., from 175° C. to 300° C., from 200° C. to 300° C., from 225° C. to 300° C., from 250° C. to 300° C., from 275° C. to 300° C., from 100° C. to 275° C., from 125° C. to 275° C., from 150° C. to 275° C., from 175° C. to 275° C., from 200° C. to 275° C., from 225° C. to 275° C., from 250° C. to 275° C., from 100° C. to 250° C., from 125° C. to 250° C., from 150° C. to 250° C., from 175° C. to 250° C., from 200° C. to 250° C., from 225° C. to 250° C., from 100° C. to 225° C., from 125° C. to 225° C., from 150° C. to 225° C., from 175° C. to 225° C., from 200° C. to 225° C., from 100° C. to 200° C., from 125° C. to 200° C., from 150° C. to 200° C., from 175° C. to 200° C., from 100° C. to 175° C., from 125° C. to 175° C., from 150° C. to 175° C., from 100° C. to 150° C., from 125° C. to 150° C., or from 100° C. to 125° C.

In one or more embodiments, the flow of the first desorbent stream 201a or 201b to the adsorption zone during the adsorption process is a LHSV from 10.0 h⁻¹ to 20.0 h⁻¹, such as from 11.0 h⁻¹ to 20.0 h⁻¹, from 12.0 h⁻¹ to 20.0 h⁻¹, from 13.0 h⁻¹ to 20.0 h⁻¹, from 14.0 h⁻¹ to 20.0 h⁻¹, from 15.0 h⁻¹ to 20.0 h⁻¹, from 16.0 h⁻¹ to 20.0 h⁻¹, from 17.0 h⁻¹ to 20.0 h⁻¹, from 18.0 h⁻¹ to 20.0 h⁻¹, from 19.0 h⁻¹ to 20.0 h⁻¹, from 10.0 h⁻¹ to 19.0 h⁻¹, from 11.0 h⁻¹ to 19.0 h⁻¹, from 12.0 h⁻¹ to 19.0 h⁻¹, from 13.0 h⁻¹ to 19.0 h⁻¹, from 14.0 h⁻¹ to 19.0 h⁻¹, from 15.0 h⁻¹ to 19.0 h⁻¹, from 16.0 h⁻¹ to 19.0 h⁻¹, from 17.0 h⁻¹ to 19.0 h⁻¹, from 18.0 h⁻¹ to 19.0 h⁻¹, from 10.0 h⁻¹ to 18.0 h⁻¹, from 11.0 h⁻¹ to 18.0 h⁻¹, from 12.0 h⁻¹ to 18.0 h⁻¹, from 13.0 h⁻¹ to 18.0 h⁻¹, from 14.0 h⁻¹ to 18.0 h⁻¹, from 15.0 h⁻¹ to 18.0 h⁻¹, from 16.0 h⁻¹ to 18.0 h⁻¹, from 17.0 h⁻¹ to 18.0 h⁻¹, from 10.0 h⁻¹ to 17.0 h⁻¹, from 11.0 h⁻¹ to 17.0 h⁻¹, from 12.0 h⁻¹ to 17.0 h⁻¹, from 13.0 h⁻¹ to 17.0 h⁻¹, from 14.0 h⁻¹ to 17.0 h⁻¹, from 15.0 h⁻¹ to 17.0 h⁻¹, from 16.0 h⁻¹ to 17.0 h⁻¹, from 10.0 h⁻¹ to 16.0 h⁻¹, from 11.0 h⁻¹ to 16.0 h⁻¹, from 12.0 h⁻¹ to 16.0 h⁻¹, from 13.0 h⁻¹ to 16.0 h⁻¹, from 14.0 h⁻¹ to 16.0 h⁻¹, from 15.0 h⁻¹ to 16.0 h⁻¹, from 10.0 h⁻¹ to 15.0 h⁻¹, from 11.0 h⁻¹ to 15.0 h⁻¹, from 12.0 h⁻¹ to 15.0 h⁻¹, from 13.0 h⁻¹ to 15.0 h⁻¹, from 14.0 h⁻¹ to 15.0 h⁻¹, from 10.0 h⁻¹ to 14.0 h⁻¹, from 11.0 h⁻¹ to 14.0 h⁻¹, from 12.0 h⁻¹ to 14.0 h⁻¹, from 13.0 h⁻¹ to 14.0 h⁻¹, from 10.0 h⁻¹ to 13.0 h⁻¹, from 11.0 h⁻¹ to 13.0 h⁻¹, from 12.0 h⁻¹ to 13.0 h⁻¹, from 10.0 h⁻¹ to 12.0 h⁻¹, from 11.0 h⁻¹ to 12.0 h⁻¹, or from 10.0 h⁻¹ to 11.0 h⁻¹.

A desorbed bottoms that is rich in n-paraffins is collected, in embodiments, at the bottom of the adsorption zone that has been regenerated. The desorbent, such as n-pentane or hexane, is flushed from the desorbed bottoms and recycled to an adsorption zone as first desorbent stream 201a or second desorbent stream 201b. In one or more embodiments, the desorbent is separated from the n-paraffins by distillation. The n-paraffins then exit the adsorption unit 110 as n-paraffin stream 102.

In one or more embodiments, the n-paraffin stream 102 that exits the adsorption unit comprises at least 95 wt. % n-paraffins, such as at least 95.5 wt. % n-paraffins, at least 96.0 wt. % n-paraffins, at least 96.5 wt. % n-paraffins, at least 97.0 wt. % n-paraffins, at least 97.5 wt. % n-paraffins, at least 98.0 wt. % n-paraffins, at least 98.5 wt. % n-paraffins, at least 99.0 wt. % n-paraffins, or at least 99.5 wt. % n-paraffins. In embodiments, the n-paraffin stream 102 that exits the adsorption unit comprises from 95.0 wt. % to 99.5 wt. % n-paraffins, such as from 95.5 wt. % to 99.5 wt. % n-paraffins, from 96.0 wt. % to 99.5 wt. % n-paraffins, from 96.5 wt. % to 99.5 wt. % n-paraffins, from 97.0 wt. % to 99.5 wt. % n-paraffins, from 97.5 wt. % to 99.5 wt. % n-paraffins, from 98.0 wt. % to 99.5 wt. % n-paraffins, from 98.5 wt. % to 99.5 wt. % n-paraffins, from 99.0 wt. % to 99.5 wt. % n-paraffins, from 95.0 wt. % to 99.0 wt. % n-paraffins, from 95.5 wt. % to 99.0 wt. % n-paraffins, from 96.0 wt. % to 99.0 wt. % n-paraffins, from 96.5 wt. % to 99.0 wt. % n-paraffins, from 97.0 wt. % to 99.0 wt. % n-paraffins, from 97.5 wt. % to 99.0 wt. % n-paraffins, from 98.0 wt. % to 99.0 wt. % n-paraffins, from 98.5 wt. % to 99.0 wt. % n-paraffins, from 95.0 wt. % to 98.5 wt. % n-paraffins, from 95.5 wt. % to 98.5 wt. % n-paraffins, from 96.0 wt. % to 98.5 wt. % n-paraffins, from 96.5 wt. % to 98.5 wt. % n-paraffins, from 97.0 wt. % to 98.5 wt. % n-paraffins, from 97.5 wt. % to 98.5 wt. % n-paraffins, from 98.0 wt. % to 98.5 wt. % n-paraffins, from 95.0 wt. % to 98.0 wt. % n-paraffins, from 95.5 wt. % to 98.0 wt. % n-paraffins, from 96.0 wt. % to 98.0 wt. % n-paraffins, from 96.5 wt. % to 98.0 wt. % n-paraffins, from 97.0 wt. % to 98.0 wt. % n-paraffins, from 97.5 wt. % to 98.0 wt. % n-paraffins, from 95.0 wt. % to 97.5 wt. % n-paraffins, from 95.5 wt. % to 97.5 wt. % n-paraffins, from 96.0 wt. % to 97.5 wt. % n-paraffins, from 96.5 wt. % to 97.5 wt. % n-paraffins, from 97.0 wt. % to 97.5 wt. % n-paraffins, from 95.0 wt. % to 97.0 wt. % n-paraffins, from 95.5 wt. % to 97.0 wt. % n-paraffins, from 96.0 wt. % to 97.0 wt. % n-paraffins, from 96.5 wt. % to 97.0 wt. % n-paraffins, from 95.0 wt. % to 96.5 wt. % n-paraffins, from 95.5 wt. % to 96.5 wt. % n-paraffins, from 96.0 wt. % to 96.5 wt. % n-paraffins, from 95.0 wt. % to 96.0 wt. % n-paraffins, from 95.5 wt. % to 96.0 wt. % n-paraffins, or from 95.0 wt. % to 95.5 wt. % n-paraffins.

With reference again to FIG. 2, iso-paraffin stream 103 and n-paraffin stream 102 exit the adsorption unit as effluents. It should be understood that at any given time, iso-paraffin stream 103 that exits the adsorption unit 110 comprises the first iso-paraffin stream 103a from the first adsorption zone 110a, second iso-paraffin stream 103b from the second adsorption zone 110b, or a combination of the first iso-paraffin stream 103a and the second iso-paraffin stream 103b. Similarly, in embodiments, at any given time, n-paraffin stream 102 that exits adsorption unit 110 comprises the first n-paraffin stream 102a from the first adsorption zone 110a, the second n-paraffin stream 102b from the second adsorption zone 110b, or a combination of the first n-paraffin stream 102a and the second n-paraffin stream 102b.

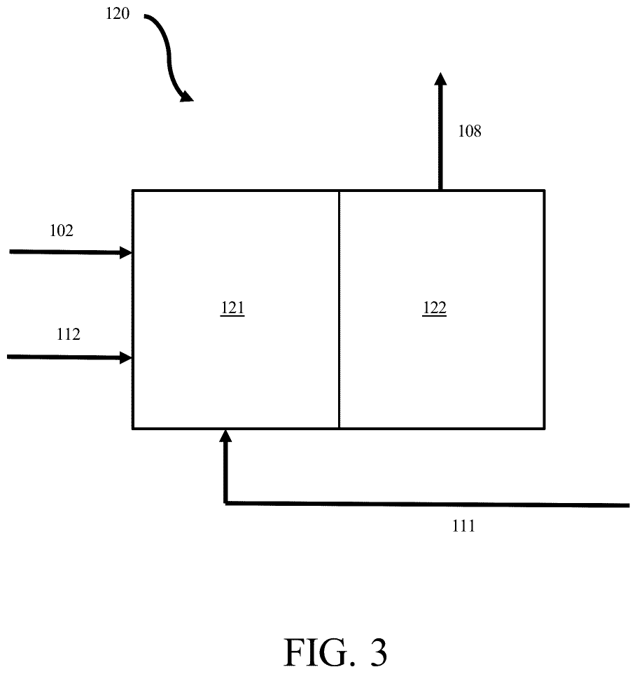

With reference again to FIG. 1, n-paraffin stream 102 exits the adsorption unit 110 and is transferred to the steam cracking unit 120. Referring to now to FIG. 3, the steam cracking unit 120 may be operable to contact the n-paraffin stream 102 with steam 112 at a temperature sufficient to cause at least a portion of the hydrocarbons in the n-paraffin stream to undergo a hydrocracking reaction to produce first BTX and olefin stream 108 that includes an increased concentration of olefins, aromatic compounds, or both.

The steam cracking unit 120 may include a convection zone 121 and a pyrolysis zone 122. The n-paraffin stream 102 may pass into the convection zone 121 along with steam 112. In embodiments, raffinate stream 111, which will be discussed in more detail below, is introduced into the convection zone 121. In the convection zone 121, the n-paraffin stream may be pre-heated to a desired temperature, such as from 400° C. to 650° C. The contents of the n-paraffin stream 102 present in the convection zone 121 may then be passed to the pyrolysis zone 122 where it is steam-cracked to produce the first BTX and olefin stream 108. The first BTX and olefin stream 108 may exit the steam cracking unit 120 and be passed through a heat exchanger (not shown) where a process fluid, such as water or pyrolysis fuel oil, cools the first BTX and olefin stream 108. The first BTX and olefin stream 108 may include a mixture of cracked hydrocarbon-based materials which may be separated into one or more petrochemical products included in one or more system product streams. The pyrolysis zone 122 may operate at a temperature of from 700° C. to 900° C. The pyrolysis zone 122 may operate with a residence time of from 0.05 seconds to 2 seconds. The mass ratio of steam 112 to the n-paraffin stream 102 may be from about 0.3:1 to about 2:1.

By providing n-paraffin stream 102 to the steam cracking unit 120 instead of naphtha feed stream 101, the ethylene yield may be increases by at least 15 wt. %, such as at least 20 wt. %, or at least 25 wt. %; the total olefin yield increased by at least 6 wt. %, at least 8 wt. %, or at least 10 wt. %; and N+2A in the separated naphtha increases by at least 15 wt. %, at least 18 wt. %, or at least 20 wt. %. The aromatic yield is also increased.

With reference again to FIG. 1, the iso-paraffin stream 103 exits the adsorption unit 110 and is introduced into the splitting unit 130. In the splitting unit 130, the iso-paraffin stream 103 is split into a lower boiling point iso-paraffin stream 104 and a higher boiling point iso-paraffin stream 105. The lower boiling point iso-paraffin stream 104 comprises iso-paraffins with boiling points that are less than 65° C. The higher boiling point iso-paraffin stream 105 comprises iso-paraffins with boiling points from 65° C. to 180° C., naphthalene, and aromatics.

In embodiments, the higher boiling point iso-paraffin stream 105 comprises from 40 wt % to 60 wt % iso-paraffins, such as from 42 wt % to 60 wt % iso-paraffins, from 45 wt % to 60 wt % iso-paraffins, from 48 wt % to 60 wt % iso-paraffins, from 50 wt % to 60 wt % iso-paraffins, from 52 wt % to 60 wt % iso-paraffins, from 55 wt % to 60 wt % iso-paraffins, from 58 wt % to 60 wt % iso-paraffins, from 40 wt % to 58 wt % iso-paraffins, from 42 wt % to 58 wt % iso-paraffins, from 45 wt % to 58 wt % iso-paraffins, from 48 wt % to 58 wt % iso-paraffins, from 50 wt % to 58 wt % iso-paraffins, from 52 wt % to 58 wt % iso-paraffins, from 55 wt % to 58 wt % iso-paraffins, from 40 wt % to 55 wt % iso-paraffins, from 42 wt % to 55 wt % iso-paraffins, from 45 wt % to 55 wt % iso-paraffins, from 48 wt % to 55 wt % iso-paraffins, from 50 wt % to 55 wt % iso-paraffins, from 52 wt % to 55 wt % iso-paraffins, from 40 wt % to 52 wt % iso-paraffins, from 42 wt % to 52 wt % iso-paraffins, from 45 wt % to 52 wt % iso-paraffins, from 48 wt % to 52 wt % iso-paraffins, from 50 wt % to 52 wt % iso-paraffins, from 40 wt % to 50 wt % iso-paraffins, from 42 wt % to 50 wt % iso-paraffins, from 45 wt % to 50 wt % iso-paraffins, from 48 wt % to 50 wt % iso-paraffins, from 40 wt % to 48 wt % iso-paraffins, from 42 wt % to 48 wt % iso-paraffins, from 45 wt % to 48 wt % iso-paraffins, from 40 wt % to 45 wt % iso-paraffins, from 42 wt % to 45 wt % iso-paraffins, or from 40 wt % to 42 wt % iso-paraffins.

In embodiments, the higher boiling point iso-paraffin stream 105 comprises from 35 wt % to 55 wt % napthalene, such as from 38 wt % to 55 wt % naphthalene, from 40 wt % to 55 wt % naphthalene, from 42 wt % to 55 wt % naphthalene, from 45 wt % to 55 wt % naphthalene, from 48 wt % to 55 wt % naphthalene, from 50 wt % to 55 wt % naphthalene, from 52 wt % to 55 wt % naphthalene, from 35 wt % to 52 wt % napthalene, from 38 wt % to 52 wt % naphthalene, from 40 wt % to 52 wt % naphthalene, from 42 wt % to 52 wt % naphthalene, from 45 wt % to 52 wt % naphthalene, from 48 wt % to 52 wt % naphthalene, from 50 wt % to 52 wt % naphthalene, from 35 wt % to 50 wt % napthalene, from 38 wt % to 50 wt % naphthalene, from 40 wt % to 50 wt % naphthalene, from 42 wt % to 50 wt % naphthalene, from 45 wt % to 50 wt % naphthalene, from 48 wt % to 50 wt % naphthalene, from 35 wt % to 48 wt % napthalene, from 38 wt % to 48 wt % naphthalene, from 40 wt % to 48 wt % naphthalene, from 42 wt % to 48 wt % naphthalene, from 45 wt % to 48 wt % naphthalene, from 35 wt % to 45 wt % napthalene, from 38 wt % to 45 wt % naphthalene, from 40 wt % to 45 wt % naphthalene, from 42 wt % to 45 wt % naphthalene, from 35 wt % to 42 wt % napthalene, from 38 wt % to 42 wt % naphthalene, from 40 wt % to 42 wt % naphthalene, from 35 wt % to 40 wt % napthalene, from 38 wt % to 40 wt % naphthalene, or from 35 wt % to 38 wt % naphthalene.

In embodiments, the higher boiling point iso-paraffin stream 105 comprises from 5 wt % to 15 wt % aromatics, such as from 8 wt % to 15 wt % aromatics, from 10 wt % to 15 wt % aromatics, from 12 wt % to 15 wt % aromatics, from 5 wt % to 12 wt % aromatics, from 8 wt % to 12 wt % aromatics, from 10 wt % to 12 wt % aromatics, from 5 wt % to 10 wt % aromatics, from 8 wt % to 10 wt % aromatics, or from 5 wt % to 8 wt % aromatics.

In embodiments, the splitting unit 130 may be a distillation unit; however, in embodiments, any unit capable of splitting iso-paraffins with a boiling point less than 65° C. from iso-paraffins with a boiling point from 65° C. to 180° C., naphthalenes, and aromatics may be used. In one or more embodiments, the splitting unit 130 can be a conventional naphtha splitting column with an inlet temperature from 100° C. to 120° C., such as from 105° C. to 115° C., or from 105° C. to 110° C.

The lower boiling point iso-paraffin stream 104 exits the splitting unit 130 and is introduced into the aromatization unit 140. In the aromatization unit 140, the iso-paraffins present in the lower boiling point iso-paraffin stream 104 are aromatized to increase the content of BTX and olefins, such as increasing the ethylene content. It should be understood that any suitable aromatization unit that increases the BTX and olefin, such as increases the ethylene content, of the lower boiling point iso-paraffin stream 104 may be used as aromatization unit 140. In one or more embodiments, the aromatization unit 140 may be a fixed-bed reactor using a gallium ZSM-5 zeolite (Ga/ZSM-5) based catalyst. The fixed bed reactor may be operated at temperatures from 530° C. to 570° C., such as from 535° C. to 565° C., from 540° C. to 560° C., from 545° C. to 555° C., or about 550° C., with weight hourly space velocity (WHSV) from 1.5 h⁻¹ to 2.5 h⁻¹, such as from 1.8 h⁻¹ to 2.2 h⁻¹, or about 2.0 h⁻¹, and a pressure from 2 bar to 7 bar, such as from 3 bar to 6 bar, from 4 bar to 5 bar, or about 5 bar. The aromatized stream 106 exits the aromatization unit 140 and is introduced into the separating unit 160. The aromatized stream comprises from 40 wt % to 70 wt % aromatics, such as from 45 wt % to 70 wt % aromatics, from 50 wt % to 70 wt % aromatics, from 55 wt % to 70 wt % aromatics, from 60 wt % to 70 wt % aromatics, from 65 wt % to 70 wt % aromatics, from 40 wt % to 65 wt % aromatics, from 45 wt % to 65 wt % aromatics, from 50 wt % to 65 wt % aromatics, from 55 wt % to 65 wt % aromatics, from 60 wt % to 65 wt % aromatics, from 40 wt % to 60 wt % aromatics, from 45 wt % to 60 wt % aromatics, from 50 wt % to 60 wt % aromatics, from 55 wt % to 60 wt % aromatics, from 40 wt % to 55 wt % aromatics, from 45 wt % to 55 wt % aromatics, from 50 wt % to 55 wt % aromatics, from 40 wt % to 50 wt % aromatics, from 45 wt % to 50 wt % aromatics, or from 40 wt % to 45 wt % aromatics.

The higher boiling point iso-paraffin stream exits the splitting unit 130 and is introduced into the reforming unit 150. In the reforming unit 150, the iso-paraffins, naphthalene, and aromatics present in the higher boiling point iso-paraffin stream 105 are reformed to increase the content of BTX and olefins, such as increasing the ethylene content. It should be understood that any suitable reforming unit that increases the BTX and olefin, such as increases the ethylene content, of the higher boiling point iso-paraffin stream 105 may be used as reforming unit 150. In one or more embodiments, the reforming unit 150 can be any conventional reforming unit, such as, for example, UOP Platformer process operating at temperatures from 495° C. to 520° C., such as 500° C. to 515° C., or from 505° C. to 510° C., pressures from 4 bar to 45 bar, such as from 10 bar to 35 bar, from 15 bar to 30 bar, from 20 bar to 25 bar, and a liquid hourly space velocity (LHSV) from 1 h⁻¹ to 5 h⁻¹, such as from 2 h⁻¹ to 4 h⁻¹, or about 3 h⁻¹. The reformed stream 107 comprising, according to embodiments, from 55 wt % to 60 wt % BTX exits the reforming unit 150 and is introduced into the separating unit 160.

The aromatized stream 106 and reformed stream 107 are introduced into the separating unit 160. In the separating unit 160, the aromatized stream 106 and the reformed stream 107 are mixed and n-paraffins are separated from BTX and olefin products. The BTX and olefin products exit the separating unit 160 as the second BTX and olefin stream 109. Although a single BTX and olefin stream 109 is depicted in FIG. 1, it should be understood that depending on the separations conducted in the separating unit 160, in embodiments the BTX and olefin stream 109 may be multiple different streams, such as streams of lower boiling point and higher boiling point olefins, streams of lower boiling point and higher boiling point aromatics, and the like. The separation unit 160 can be any conventional splitter. The n-paraffins exit the separating unit 160 as raffinate stream 111 are recycled back to the steam cracking unit 120 where they may be converted to BTX and olefins.

In embodiments, the raffinate stream 111 comprises from 80 wt % to 90 wt % C₅ paraffins, such as from 82 wt % to 90 wt % C₅ paraffins, from 85 wt % to 90 wt % C₅ paraffins, from 88 wt % to 90 wt % C₅ paraffins, from 80 wt % to 88 wt % C₅ paraffins, from 82 wt % to 88 wt % C₅ paraffins, from 85 wt % to 88 wt % C₅ paraffins, from 80 wt % to 85 wt % C₅ paraffins, from 82 wt % to 85 wt % C₅ paraffins, or from 80 wt % to 82 wt % C₅ paraffins. In embodiments, the raffinate stream 111 comprises from 10 wt % to 20 wt % C₆ paraffins, such as from 12 wt % to 20 wt % C₆ paraffins, from 15 wt % to 20 wt % C₆ paraffins, from 18 wt % to 20 wt % C₆ paraffins, from 10 wt % to 18 wt % C₆ paraffins, from 12 wt % to 18 wt % C₆ paraffins, from 15 wt % to 18 wt % C₆ paraffins, from 10 wt % to 15 wt % C₆ paraffins, from 12 wt % to 15 wt % C₆ paraffins, or from 10 wt % to 12 wt % C₆ paraffins.

### EXAMPLES

The various embodiments of methods and systems for the processing of naphtha will be further clarified by the following examples. The examples are illustrative in nature, and should not be understood to limit the subject matter of the present disclosure.

### Example 1: Comparison of n-Paraffins and Iso-Paraffins in Steam Cracking

In Example 1, two steam cracking simulations were run using SPYRO 6 simulation software from Technip Energies. The first steam cracking simulation utilized a feed stream comprising n-butane, and the second steam cracking simulation utilized iso-butane as the feed stream. The results provide a comparison of yields when n-paraffins are used in steam cracking compared to iso-paraffins used in steam cracking.

Both the n-butane and the iso-butane simulations were conducting using steam cracking at 840° C. for a time period of 0.4 seconds. The steam to oil ratio was set to 0.6. The chemical make-up of the yield streams are provided in Table 1 below where the yields are provided in weight percent. In Table 1, E+P+B olefin is the sum of ethylene (C₂H₄), propylene (C₃H₆), and butene (C₄H₈).

TABLE 1

| | n-butane | iso-butane |
|---|---|---|
| H₂ | 1.09 | 1.26 |
| CH₄ | 24.57 | 27.38 |
| C₂H₂ | 0.64 | 0.73 |
| C₂H₄ | 38.42 | 16.55 |
| C₂H₆ | 3.89 | 0.61 |
| C₃H₄ | 0.94 | 2.82 |
| C₃H₆ | 12.6 | 15.8 |
| C₃H₈ | 0.08 | 0.33 |
| C₄H₆ | 3.86 | 2.42 |
| C₄H₈ | 0.99 | 14.07 |
| C₄H₁₀ | 1.75 | 2.79 |
| C₅ Plus | 11.17 | 15.24 |
| E + P + B olefin | 52.01 | 46.42 |
| Total | 100 | 100 |

As shown in Table 1, the yield for ethylene is 21.87 wt. % higher when using n-butane compared to iso-butane, and the total olefin yield (E+P+B olefin) is 5.6 wt. % higher when using n-butane compared to iso-butane. Thus, the total olefin yield and particularly the ethylene yield for steam cracking is much higher when using n-paraffins compared to iso-paraffins.

Even though the above example utilizes n-butane and iso-butane, it would be expected that other n-paraffins and iso-paraffins would have similar outcomes because the n-batane and iso-butane have the biggest difference in steam cracking olefin yield. Thus, with a carbon number decrease (from the C₄ of butane) ethylene and propylene difference would become smaller. However, when the carbon number increases to 7 (n-heptane and iso-heptane) there is no significant difference in olefin yield.

### Example 2: Adsorption of n-Paraffins with Zeolite 5A

In Example 2, the adsorption efficiency of n-paraffins using a zeolite 5A adsorbent was tested by loading an absorption zone with zeolite 5A and then introducing straight run naphtha from a refinery to the loaded adsorption zone. The operating conditions during the n-paraffin adsorption process were atmospheric pressure, 180° C., LHSV of naphtha of 0.025 h⁻¹. When the zeolite 5A adsorbent was saturated, the adsorbent was regenerated using n-pentene. The regeneration operating conditions were atmospheric pressure, 180° C., LHSV of n-pentene of 12 h⁻¹. The chemical make-up of the iso-paraffin stream exiting the adsorption zone during the adsorption process and the n-paraffin stream collected after regeneration are provided in Table 2 below.

TABLE 2

| | n-paraffin | iso-paraffin | Naphthalene | Aromatics |
|---|---|---|---|---|
| Naphtha stream | 25.6 | 37.0 | 26.7 | 10.7 |
| iso-paraffin stream | 0.14 | 49.6 | 35.9 | 14.4 |
| n-paraffin stream | 97.5 | 1.2 | 0.9 | 0.4 |

As shown in Table 2, the zeolite 5A effectively adsorbs and separates n-paraffins from iso-paraffins.

### Example 3: Comparison of Steam Cracking Using Naphtha, Iso-Paraffin Stream, and n-Paraffin Stream

In Example 3, a simulation was conducted using the streams provided from the adsorption in Example 2 in a steam cracking unit. Three steam cracking simulations were conducted using the naphtha stream from Example 2 in one simulation, using the iso-paraffin stream from Example 2 in one simulation, and using the n-paraffin stream from Example 2 in one simulation. The steam cracking conditions were a temperature of 850° C., pressure of 1.8 bar, steam/hydrocarbon ratio: 0.5 kg/kg, and a residence time of 0.34 seconds. The yields of ethylene, propylene, and butane in weight percent from each of the simulations are provide in Table 3 below.

TABLE 3

| | Ethylene | Propylene | Butene | Total E + P + B |
|---|---|---|---|---|
| naphtha stream | 31.4 | 16.6 | 6.7 | 54.7 |
| iso-paraffin stream | 25.8 | 16.5 | 7.0 | 49.3 |
| n-paraffin stream | 49.1 | 15.8 | 5.4 | 70.3 |

As shown in Table 3, the overall olefin yield for the n-paraffin stream is 15.6 wt. % higher than the naphtha stream, and the ethylene yield for the n-paraffin stream is 17.7 wt. % higher than the naphtha stream.

### Example 4: Comparison of Steam Cracking n-Paraffins and Reforming Iso-Paraffins to Steam Cracking Naphtha or Reforming Naphtha

In Example 4, three simulations were conducted to compare the yield of steam cracking naphtha, the yield of reforming naphtha, and the yield from a combination of steam cracking n-paraffins and reforming iso-paraffins. In the first simulation, a naphtha stream as provided in Example 2 was steam cracked using the parameters provided in Example 1. In the second simulation a naphtha stream as provided in Example 2 was reformed with a commercialized Pt/Al₂O₃ catalyst, a temperature of 520° C., a pressure of 5 bar, and LHSV 1.5 h¹. In the third simulation an n-paraffin stream as provided in Example 2 was steam cracked using the parameters provided in Example 1, and an iso-paraffin stream as provided in Example 2 was reformed using the parameters in the second simulation. The yields of ethylene, propylene, butane, and BTX in weight percent are provided in Table 4 below.

TABLE 4

| | Simulation 1 | Simulation 2 | Simulation 3 | |
|---|---|---|---|---|
| | Naphtha | Naphtha | n-paraffin | iso-paraffin |
| | to steam | to reforming | to steam | to reforming |
| | cracking unit | unit | cracking unit | unit |
| Feed, wt. % | 100 | 100 | 25.7 | 74.3 |
| Ethylene | 31.4 | | 11.8 | |
| Propylene | 16.6 | | 3.8 | |
| Butene | 6.7 | | 1.1 | |
| E + P + B | 54.7 | 2.0 | 16.7 | 1.5 |
| BTX | 11.3 | 60.0 | 7.0 | 52.0 |

| | | | |
|---|---|---|---|
| Total Yield | 66 | 62.0 | 77.2 |

In Table 4, the E+P+B in simulation 2 and the E+P+B in the iso-paraffin to reforming unit of Simulation 3 are calculated from the reforming product.

As shown in Table 4, the total chemical yield of Simulation 3 is 11 wt. % higher than when naphtha is steam cracked and more than 15 wt. % higher than when naphtha is reformed.

A first aspect includes process for forming olefins and aromatics from naphtha comprising introducing a naphtha feed stream to an adsorption unit, the adsorption unit comprising an adsorbent; adsorbing n-paraffins from the naphtha feed stream to the adsorbent; removing an iso-paraffin stream from the adsorption unit; introducing a desorbent stream into the adsorption unit, the desorbent stream comprising a desorbent; removing the n-paraffins from the adsorbent with the desorbent, thereby forming desorbed bottoms; collecting the n-paraffins from the desorbed bottoms, thereby forming an n-paraffin stream; introducing the n-paraffin stream to a steam cracking unit; and forming olefins and aromatics from the n-paraffin stream in the steam cracking unit.

A second aspect includes the process of aspect 1, wherein the iso-paraffin stream is introduced to a splitting unit that splits the iso-paraffin stream into a lower boiling point iso-paraffin stream and a higher boiling point iso-paraffin stream.

A third aspect includes the process of aspects 1 and 2, wherein the lower boiling point iso-paraffin stream is introduced into an aromatization unit where the lower boiling point iso-paraffin stream is aromatized into an aromatized stream, and the higher boiling point iso-paraffin stream is introduced into a reforming unit where the higher boiling point iso-paraffin stream is reformed into a reformed stream.

A fourth aspect includes the process of aspects 1 to 3, wherein the aromatized stream and the reformed stream are introduced into a separation unit.

A fifth aspect includes the process of aspects 1 to 4, wherein the aromatized stream and the reformed stream are mixed together in the separation unit and separated into a BTX and olefin stream and a raffinate stream, wherein the raffinate stream comprises n-paraffins.

A sixth aspect includes the process of aspects 1 to 5, wherein the raffinate stream is recycled back to the steam cracking unit.

A seventh aspect includes the process of aspects 1 to 6, wherein the adsorbent is selected from the group consisting of zeolite 5A, zeolite T, chabazite, and erionite.

An eighth aspect includes the process of aspects 1 to 7, wherein the adsorbent is dried in air or nitrogen at a temperature that is from 350° C. to 550° C. for a duration that is from 2 hours to 12 hours before adsorbing n-paraffins from the naphtha feed stream to the adsorbent.

A ninth aspect includes the process of aspects 1 to 8, wherein the adsorbing n-paraffins from the naphtha feed stream to the adsorbent is conducted at a temperature that is from 100° C. to 300° C. and a liquid space velocity that is from 0.001 h⁻¹ to 10 h⁻¹.

A tenth aspect includes the process of aspects 1 to 9, wherein the desorbent is selected from n-pentane or hexane.

An eleventh aspect includes the process of aspects 1 to 10, wherein removing the n-paraffins from the adsorbent with the desorbent stream is conducted at a temperature that is from 100° C. to 300° C. and a liquid space velocity that is from 10.0 h⁻¹ to 20.0 h⁻¹.

A twelfth aspect includes the process of aspects 1 to 11, wherein the n-paraffin stream comprises at least 95.0 wt. % n-paraffins.

A thirteenth aspect includes the process of aspects 1 to 12, wherein the iso-paraffin stream comprises at least 95.0 wt. % iso-paraffins.

A fourteenth aspect includes the process of aspects 1 to 13, wherein the adsorption unit comprises a first adsorption zone and a second adsorption zone, each of the first adsorption zone and the second adsorption zone comprise the adsorbent, a first naphtha feed stream is introduced to the first adsorption zone while a second desorbent stream is introduced to the second adsorption zone, and a first desorbent stream is introduced to the first adsorption zone while a second naphtha feed stream is introduced to the second adsorption zone, and the first naphtha feed stream and the first desorbent stream are not simultaneously introduced to the first adsorption zone, and the second naphtha feed stream and the second desorbent stream are not simultaneously introduced to the second adsorption zone.

A fifteenth aspect includes a system for forming olefins and aromatics from naphtha, the system comprising: an adsorption unit upstream from and fluidly connected to a splitting unit and a steam cracking unit; the steam cracking unit is downstream from and fluidly connected to the adsorption unit and is upstream from and fluidly connected to a separation unit; the splitting unit is downstream from and fluidly connected to the adsorption unit, and is upstream from and fluidly connected to an aromatization unit and a reforming unit; the aromatization unit is downstream from and fluidly connected to the splitting unit, and is upstream from and fluidly connected to the separation unit; the reforming unit is downstream from and fluidly connected to the splitting unit, and is upstream from and fluidly connected to the separation unit; the separation unit is downstream from and fluidly connected to the aromatization unit and the reforming unit, and is downstream from and fluidly connected to the steam cracking unit, wherein the adsorption unit comprises an adsorbent selected from the group consisting of zeolite 5A, zeolite T, chabazite, and erionite.

A sixteenth aspect includes the system of aspect 15, wherein the adsorbent is zeolite 5A.

A seventeenth aspect includes the system of aspects 15 and 16, wherein the adsorption unit is configured to adsorb n-paraffins and allow iso-paraffins to pass through the adsorption unit.

An eighteenth aspect includes the system of aspects 15 to 17, wherein the adsorption unit is configured so that iso-paraffins exiting the adsorption unit are introduced into the splitting unit and so that n-paraffins exiting the adsorption unit are introduced into the steam cracking unit.

A nineteenth aspect includes the system of aspects 15 to 18, wherein the adsorption unit comprises a first adsorption zone and a second adsorption zone, each of the first adsorption zone and the second adsorption zone comprises the adsorbent.

A twentieth aspect includes the system of aspects 15 to 19, wherein the first adsorption zone and the second adsorption zone are configured so that: a first naphtha feed stream is introduced to the first adsorption zone while a second desorbent stream is introduced to the second adsorption zone; a first desorbent stream is introduced to the first adsorption zone while a second naphtha feed stream is introduced to the second adsorption zone; the first naphtha feed stream and the first desorbent stream are not simultaneously introduced to the first adsorption zone; and the second naphtha feed stream and the second desorbent stream are not simultaneously introduced to the second adsorption zone.

It is noted that one or more of the following claims utilize the terms “where” and “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that any two quantitative values assigned to a property may constitute a range of that property, and all combinations of ranges formed from all stated quantitative values of a given property are contemplated in this disclosure.

Having described the subject matter of the present disclosure in detail and by reference to specific embodiments, it is noted that the various details described in this disclosure should not be taken to imply that these details relate to elements that are essential components of the various embodiments described in this disclosure, even in cases where a particular element is illustrated in each of the drawings that accompany the present description. Rather, the claims appended hereto should be taken as the sole representation of the breadth of the present disclosure and the corresponding scope of the various embodiments described in this disclosure. Further, it will be apparent that modifications and variations are possible without departing from the scope of the appended claims.

1. A process for forming olefins and aromatics from naphtha comprising:
introducing a naphtha feed stream to an adsorption unit, the adsorption unit comprising an adsorbent;
adsorbing n-paraffins from the naphtha feed stream to the adsorbent;
removing an iso-paraffin stream from the adsorption unit;
introducing a desorbent stream into the adsorption unit, the desorbent stream comprising a desorbent;
removing the n-paraffins from the adsorbent with the desorbent, thereby forming desorbed bottoms exiting the bottom of the adsorption unit;
collecting the n-paraffins from the desorbed bottoms, thereby forming an n-paraffin stream;
introducing the n-paraffin stream to a steam cracking unit; and
forming olefins and aromatics from the n-paraffin stream in the steam cracking unit.

2. The process of claim 1, wherein the iso-paraffin stream is introduced to a splitting unit that splits the iso-paraffin stream into a lower boiling point iso-paraffin stream and a higher boiling point iso-paraffin stream.

3. The process of claim 2, wherein the lower boiling point iso-paraffin stream is introduced into an aromatization unit where the lower boiling point iso-paraffin stream is aromatized into an aromatized stream, and
the higher boiling point iso-paraffin stream is introduced into a reforming unit where the higher boiling point iso-paraffin stream is reformed into a reformed stream.

4. The process of claim 3, wherein the aromatized stream and the reformed stream are introduced into a separation unit.

5. The process of claim 4, wherein the aromatized stream and the reformed stream are mixed together in the separation unit and separated into a BTX and olefin stream and a raffinate stream, wherein the raffinate stream comprises n-paraffins.

6. The process of claim 5, wherein the raffinate stream is recycled back to the steam cracking unit.

7. The process of claim 1, wherein the adsorbent is selected from the group consisting of zeolite 5A, zeolite T, chabazite, and erionite.

8. The process of claim 1, wherein the adsorbent is dried in air or nitrogen at a temperature that is from 350° C. to 550° C. for a duration that is from 2 hours to 12 hours before adsorbing n-paraffins from the naphtha feed stream to the adsorbent.

9. The process of claim 1, wherein the adsorbing n-paraffins from the naphtha feed stream to the adsorbent is conducted at a temperature that is from 100° C. to 300° C. and a liquid space velocity that is from 0.001 h⁻¹ to 10 h⁻¹.

10. The process of claim 1, wherein the desorbent is selected from n-pentane or hexane.

11. The process of claim 1, wherein removing the n-paraffins from the adsorbent with the desorbent stream is conducted at a temperature that is from 100° C. to 300° C. and a liquid space velocity that is from 10.0 h⁻¹ to 20.0 h⁻¹.

12. The process of claim 1, wherein the n-paraffin stream comprises at least 95.0 wt. % n-paraffins.

13. The process of claim 1, wherein the iso-paraffin stream comprises at least 95.0 wt. % iso-paraffins.

14. The process of claim 1, wherein the adsorption unit comprises a first adsorption zone and a second adsorption zone, each of the first adsorption zone and the second adsorption zone comprise the adsorbent,
a first naphtha feed stream is introduced to the first adsorption zone while a second desorbent stream is introduced to the second adsorption zone, and a first desorbent stream is introduced to the first adsorption zone while a second naphtha feed stream is introduced to the second adsorption zone, and
the first naphtha feed stream and the first desorbent stream are not simultaneously introduced to the first adsorption zone, and the second naphtha feed stream and the second desorbent stream are not simultaneously introduced to the second adsorption zone.

15. A system for forming olefins and aromatics from naphtha, the system comprising:
an adsorption unit upstream from and fluidly connected to a splitting unit and a steam cracking unit;
the steam cracking unit is downstream from and fluidly connected to the adsorption unit and is upstream from and fluidly connected to a separation unit;
the splitting unit is downstream from and fluidly connected to the adsorption unit, and is upstream from and fluidly connected to an aromatization unit and a reforming unit;
the aromatization unit is downstream from and fluidly connected to the splitting unit, and is upstream from and fluidly connected to the separation unit;
the reforming unit is downstream from and fluidly connected to the splitting unit, and is upstream from and fluidly connected to the separation unit;
the separation unit is downstream from and fluidly connected to the aromatization unit and the reforming unit, and is downstream from and fluidly connected to the steam cracking unit,
wherein the adsorption unit comprises an adsorbent selected from the group consisting of zeolite 5A, zeolite T, chabazite, and erionite.

16. The system of claim 15, wherein the adsorbent is zeolite 5A.

17. The system of claim 15, wherein the adsorption unit is configured to adsorb n-paraffins and allow iso-paraffins to pass through the adsorption unit.

18. The system of claim 17, wherein the adsorption unit is configured so that iso-paraffins exiting the adsorption unit are introduced into the splitting unit and so that n-paraffins exiting the adsorption unit are introduced into the steam cracking unit.

19. The system of claim 15, wherein the adsorption unit comprises a first adsorption zone and a second adsorption zone, each of the first adsorption zone and the second adsorption zone comprises the adsorbent.

20. The system of claim 19, wherein the first adsorption zone and the second adsorption zone are configured so that:
a first naphtha feed stream is introduced to the first adsorption zone while a second desorbent stream is introduced to the second adsorption zone;
a first desorbent stream is introduced to the first adsorption zone while a second naphtha feed stream is introduced to the second adsorption zone;
the first naphtha feed stream and the first desorbent stream are not simultaneously introduced to the first adsorption zone; and
the second naphtha feed stream and the second desorbent stream are not simultaneously introduced to the second adsorption zone.
